(19) United States
(12) Patent Application Publication
(10) Pub. No.: US 2014/0068515 A1
(43) Pub. Date: Mar. 6, 2014

(54) SYSTEM AND METHOD FOR CLASSIFYING MEDIA

(71) Applicant: mindHIVE Inc., New York, NY (US)

(72) Inventors: Cem Atacik, Istanbul (TR); George Dalke, Claremont, NH (US); Oya Demirli, New York, NY (US); Suraj Khatwani, New York, NY (US)

(73) Assignee: MINDHIVE INC., New York, NY (US)

(21) Appl. No.: 14/012,394

(22) Filed: Aug. 28, 2013

Related U.S. Application Data
(60) Provisional application No. 61/694,638, filed on Aug. 29, 2012.

(51) Int. Cl. G06F 3/0482

(52) U.S. Cl. CPC G06F 3/0482
USPC 715/810

(57) ABSTRACT

The invention generally relates to classifying digital media and particularly to classifying new media as it is being provided to a media-sharing platform from a mobile device. The invention provides systems and methods for categorizing media as it is uploaded by mobile device to a media sharing platform. In certain aspects, the invention provides a method for classifying media that operates by receiving, at a server computer system, media transmitted from a mobile device by a user. A key word within the media is identified, and the server system retrieves from memory a plurality of prospective categories based on the keyword. The method includes causing the mobile device to display the prospective categories to the user, receiving a selection by the user of one of the prospective categories, and associating the media with the selected category.

### CROSS-REFERENCE TO RELATED APPLICATION

This application claims priority to U.S. provisional patent application 61/694,638, filed Aug. 29, 2012, the contents of which are incorporated by reference.

### FIELD OF THE INVENTION

The invention generally relates to classifying digital media and particularly to classifying new media as it is being provided to a media-sharing platform from a mobile device.

### BACKGROUND

Platforms exist that allow users to share media. For example, a user can take a picture and share the pictures among friends using social media platforms that may be accessed through the web or mobile apps. These platforms contribute to a near-constant generation of new media. Not a second goes by that some new picture and caption doesn't get distributed around the globe.

However, despite the fact that users are intentional participants in the media-sharing platforms, by the very nature of the media sharing, the users actually make it difficult to organize the media or to share the media with just the right interested audience. The ubiquity of mobile smartphones makes it all the more difficult to make sense of the flood of new media that is constantly being posted. The nature of a mobile device lends itself to snapping and uploading pictures, due to the high-quality cameras and viewing screens, and also to composing short fragments of captions, due to the limited keyboards offered by mobile devices. For these reasons, when people communicate through media sharing platforms accessed using mobile devices, huge quantities of newly-generated raw data in the form of snapshots with short text captions flows through the servers of sharing platforms but is disorganized. It is very difficult to retrieve postings that are all relevant to some person's interests.

### SUMMARY

The invention provides systems and methods for categorizing media as it is uploaded by a mobile device to a media sharing platform. As a user composes a posting—which can include a picture and text—a keyword is recognized and used to present to the user candidate categories for classification of the posting. Some number, such as three or six, different categories are shown on the screen of the user's mobile device. As the user types more words, recognized keywords are used to update the list of candidate categories to focus the list on categories that the user is likely to choose. The user can recognize and select the appropriate category, which is then associated with the posting. Thus, all postings made through the media sharing platform are tagged by a category that connects the content of the posting to a category that user is interested in.

To illustrate, a user who uploads a picture and types, “great fish” may be shown—on the screen of their mobile device—categories such as ‘dining’, ‘outdoor sports’, and ‘science’. If the user goes on to type the phrase as, “great fish in New York”, the categorization rules engine of systems of the invention may recognize keywords ‘fish’ and ‘New York’ and may present the more focused set of categories, “dining”, “seafood”, and “cuisine”. A user who types “great fish on the lake” may see categories for “outdoor sports” and “fishing”. While typing, a user can select a category—for example, by touching the appropriate area of the touch screen of their mobile device. Then, when the user chooses to post the picture, it will be associated with the appropriate interest. Since all of the new media is classified by the user's interest that accurately represents the content of the media, users can browse and search each other's posts to find the latest updates about their favorite interests. Additionally, the media classification scheme provides a tool for targeting communication to particular users by their interests. If it is desired to relay information to a person who is likely to be interested in a particular subject, a sender can find users who have posted to categories that indicate such interests.

Since the categorization rules engine can operate automatically by recognizing keywords, new media can be categorized automatically with little input from the user (e.g., the user just has to select from a presented list by, for example, touching a touch screen). Since the user actually selects the appropriate category once a list of candidates has been presented, the categorization is precise and accurately reflects the user's interests and the content of the media. Since the categorization engine operates as the user is composing a new post without slowing down the posting process, large volumes of media is categorized as it is created, uploaded, and shared. Since the categorization works with minimal text input such as is common for touch-screen devices, it is particularly well-suited to operate with media being uploaded from mobile devices. Since the categorization works by recognizing keywords and predicting likely categories, it is very well-suited to using the types of short text labels that users apply to pictures and thus it is particularly good for categorizing pictures and they are being uploaded and shared. Thus, systems and methods of the invention operate to accurately and precisely categorize very large volumes of pictures as many users upload pictures for mobile devices for communication over a media sharing platform.

In certain aspects, the invention provides a method for classifying media that operates by receiving, at a server computer system, media transmitted from a mobile device by a user. A key word within the media is identified, and the server system retrieves from memory a plurality of prospective categories based on the keyword. The method includes causing the mobile device to display the prospective categories to the user, receiving a selection by the user of one of the prospective categories, and associating the media with the selected category. In some embodiments, the server causes the mobile device to display the prospective categories to the user while the user is creating the media using an input mechanism on the mobile device. Optionally, additional key words are identified after causing the mobile device to display the prospective categories, and the mobile device displays an updated set of prospective categories to the user. In certain embodiments, the method involves identifying a second key word after causing the mobile device to display the prospective categories, and then retrieving an updated plurality of prospective categories based on a combination of the key word and the second key word. In a preferred embodiment, the media comprises a picture and keywords that are posted to a media sharing platform. The media may consist of an image file, an alphanumeric string, and associated metadata.

The server system may retrieve the plurality of prospective categories by selecting the prospective categories from a master list of categories. Selecting the prospective categories may include evaluating values stored for the keyword for each of a plurality of parameters (such as a standard deviation, concentration index, chi-squared value, Bayesian statistic, or others) for each of the categories in the master list. A category may be selected from the master list preferentially according to a value of one or more of the parameters associating the category to the keyword.

In related aspects, the invention provides a server system for classifying media. The system uses a processor coupled to a tangible, non-transitory memory to receive media transmitted from a mobile device by a user, identify a key word within the media, retrieve prospective categories from the memory using the keyword, and cause the mobile device to display the prospective categories to the user. The server can then receive a selection by the user of one of the prospective categories and associate the media with the selected category. Preferably, the server system is operable to select the prospective categories from a master list of categories stored in the memory by, for example, evaluating values stored for each of a plurality of parameters for each of the categories in the master list. This way, the server can select a category from the master list preferentially if one of the category's associated parameters has a high value. Preferably, the media includes a picture and keywords and the system is used to post the media to a media sharing platform.

Systems and methods of the invention operate in real-time in that the server system can cause the mobile device to display the prospective categories to the user while the user is creating the media using an input mechanism (such as a touch screen or keyboard) on the mobile device. The server can recognize additional keywords as they are entered and use them—as additional keywords or in combinations with previous keywords as a combination—to update the selected categories.

Aspects of the invention provide a process for classifying and sharing a social media post. The process involves providing a mobile device for use by a user to compose a posting (e.g., a picture and a character string) and, while the character string is being composed, displaying a list of prospective categories for classification of the posting. After the list is displayed, the list can then be updated while the character string is further being composed. The process includes receiving a selection from the user of one of the prospective categories and sharing the posting with other members of a media platform.

### BRIEF DESCRIPTION OF THE DRAWINGS

FIG. 1 shows use of a mobile device to generate new digital media.

FIG. 2 shows a device in a digital media sharing platform.

FIG. 3 depicts an exemplary registration or update screen.

FIG. 4 shows use of a media platform to share new digital media.

FIG. 5 illustrates a system for sharing media.

FIG. 6 illustrates use of device for media sharing.

FIGS. 7A-7D illustrate use of the new digital media sharing platform.

FIG. 8 depicts a home screen that may presented to a user.

FIG. 9 depicts components of system of the invention.

FIG. 10 illustrates a display on a business computer.

FIG. 11 depicts a tool for managing a communication campaign.

FIG. 12 illustrates a sample output of a simulator of the invention.

FIG. 13 diagrams steps of methods of the invention.

FIG. 14 illustrates a display through which a consumer may receive communications.

FIG. 15 gives a more detailed schematic of components that may appear within a system.

### DETAILED DESCRIPTION

The invention provides systems and methods for classifying media. Media is classified by the operation of a categorization engine. The categorization engine operates to identify which categories to display based on one or more keywords that are recognized and used as input into the analysis. The categorization engine may operate in any suitable context such as, for example, an application in which a user stores and retrieves media such as pictures, film, sounds, documents, or data files. In a preferred embodiment, the categorization engine operates for the classification of digital media within the context of a media sharing platform such as a social media site. A user may upload digital media for sharing. The uploaded media may include a picture and a short text label—a caption—that the user composes using a mobile device. As the user composes the text label, the categorization engine recognizes keywords for the association of the media with a category by, for example, displaying a list of candidate categories to the user. The categorization engine may select categories by any suitable technique such as, for example, referring to statistical evaluations of historical associations between keywords and categories. As discussed in more detail herein, in some only.—embodiments, historical relationships of keywords to categories are evaluated by standard deviation, coefficient of variation, a concentration index, a chi-squared type statistic, others or a combination thereof. Operation of the categorization engine may best be appreciated through an illustrative and non-limiting discussion of an exemplary media sharing platform.

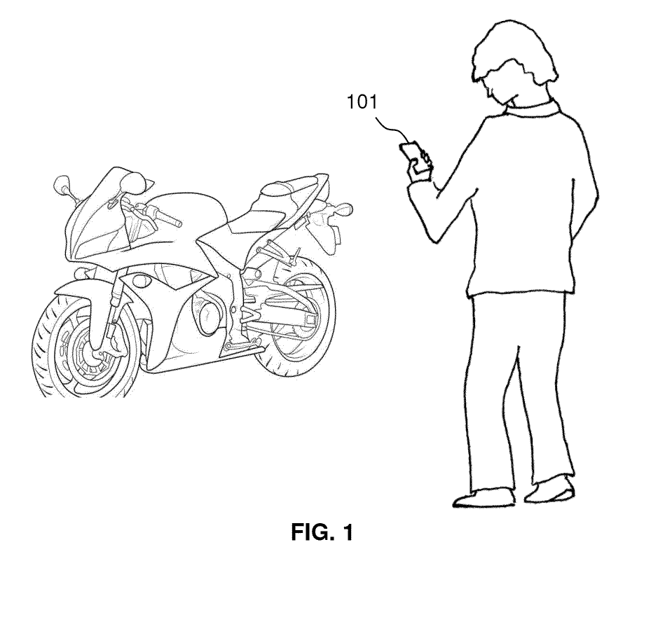

FIG. 1 shows use of a mobile device 101 to generate new digital media. In the depicted scene, a person has come across a real-world item that could be used as a subject for communication. The person takes a picture using mobile device 101, thus creating new digital media. If the person desires to communicate with friends or connections, he can engage the digital media sharing platform.

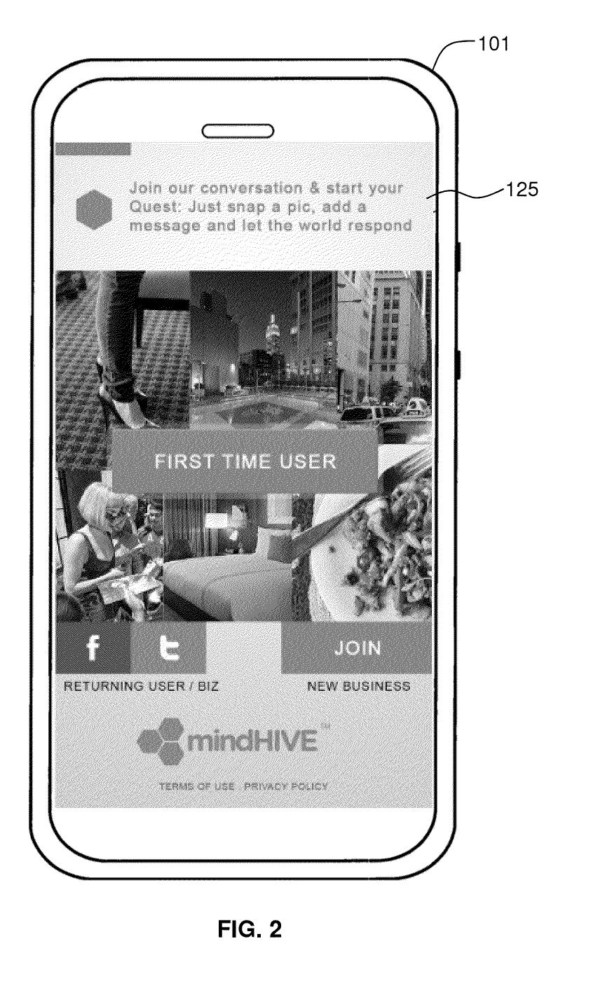

FIG. 2 shows a device 101 as viewed by a person using device 101 to engage with a digital media sharing platform. Specifically, device 101 includes a display 125 that can present interaction tools. As shown in FIG. 2, display 125 presents a screen or form that a person can use to register with a media-sharing platform (e.g., as a first-time user). One of skill in the art will recognize that any suitable registration or login screen could be presented or none. For example, in some embodiments, a person signs into the service using credentials provided by another service (e.g., “Log in using your Facesite account” is presented as an option on the screen).

Some embodiments of the invention provide a media platform that a person can use as a communication tool. Users can tailor their end of the platform to their own interests. For example, in some embodiments, a user selects one or more interests to be associated with themselves (e.g., through an account or profile).

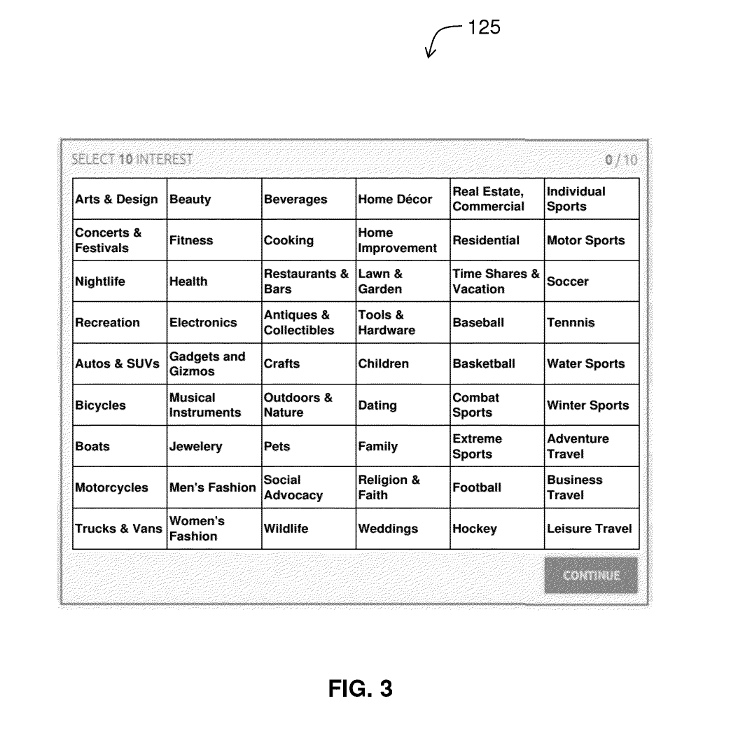

FIG. 3 depicts an exemplary registration or update screen 125 at which a user can select one or more interests to be associated with. Any suitable interests can be used such as, for example, a pre-determined list of categories; a taxonomy of nested pre-determined categories; categories derived by word-frequency analytics performed on user media; categories arrived at via a text-recognition analysis of files (e.g., pictures) within the system; category sets retrieved from other sources (e.g., “departments” listed within a shopping web site); user-entered words or titles; others; or a combination thereof.

In certain embodiments, a list of user-selectable categories is made available to a user via a screen 125 such as is shown in FIG. 3, and other categories are associated with one or more individual users via an internal business logic or rules engine. Such “behind the scenes” categories can be associated with a user by any suitable mechanism. For example, those categories shown in screen 125 in FIG. 3 can be grouped behind the scenes into meta-categories (e.g., ‘Culture’, behind the scenes, includes Arts & Designs, Concerts & Festivals, Nightlife, etc., while ‘Vehicles’ includes Autos & SUVs, Bicycles, Boats, Motorcycles, etc.) A system of the invention could include a discriminant function analysis that uses a plurality of different input information from a user to associate each user with a typifying category. For example, a function could normalize and then weight a user's self-selected categories, categories from a user's friend list, a user's demographic information from a profile, a user's location information from mobile device 101 to arrive at an index value used to a select a typifying category from a stored array. The typifying categories could include, for example, any suitable set of categories derived by a publisher's marketing team, in which each category within the set identifies a type of experience and communication that is predicted to have emotional resonance with the user. By these means, a publisher can add a layer of user-typifying classification over (or under) the user's self-identified interests, wherein the self-identified interest and the typifying classification (the X-factor) work in combination to classify information associated with the individual posts of particular users.

To further illustrate behind-the-scenes categories, a non-limiting example is given. A first user that is 23-years old and lives in Los Angeles and frequently posts pictures from live concerts may self-select motorcycles as an interest. A second user that is 68 years old and lives in Canton, Ohio, and frequently posts about gardening may select motorcycles as an interest. An analytical engine can associate the concert photos with a nightlife category and may also identify the second user as associated with a gardening category (behind the scenes, without self-selection by the user). The discriminant function may weight age, location, behind-the-scenes category, and may assign the first user to a typifying category of ‘adrenaline’ and the second user with a typifying category of ‘security’. One of skill in the art will recognize that the given images and words are illustrative examples only and that any suitable categories or words could be employed. The categorization functions aid in associating each user with one or more targeted interest that can be used to send targeted communication such as, for example, advertising offers. In some embodiments, offers are preferably sent within the context of a user's use of the media platform. Systems and methods of the invention provide and includes a media platform with particular application in sharing new digital media.

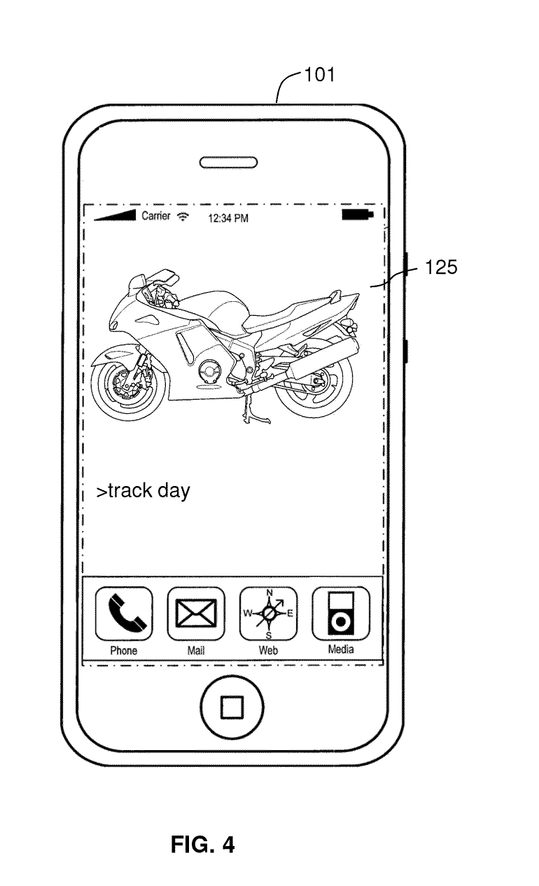

FIG. 4 shows use of a media platform to share new digital media. Here, a user has created new digital media that includes a picture just taken of an item of interest and text that the user wishes to associate with the picture. As shown in FIG. 4, the user has used mobile device 101 to compose new digital media that is being shown in display 125. The invention provides a categorization engine to classify the new digital media.

The disclosed categorization engine allows a consumer (e.g., a user who is making a post) to quickly and accurately categorize their post (image, text, other digital media, or a combination thereof) in one of a plurality of categories. Any suitable categories or number of categories. For example, in some embodiments, a set of industry-accepted categories are used. In certain embodiments, the categories shown in FIG. 3 are used. In an example, there may be 10 categories or 100. As discussed herein, the categorization engine operates in real-time in the sense that prospective categories are selected and presented as a user composes a post. The post—i.e., the new digital media—is categorized by the user's selection of one of the presented, proposed categories. The rapid and accurate categorization of the data improves the user communities' ability to retrieve and respond to relevant information in a timely manner

In some embodiments, the categorization engine operates in the context of a social media platform that includes media sharing capabilities. A social media platform may include a measure of clout for a user. In certain embodiments, a user has a measure of clout in each of one or more areas of interest. One insight of the invention is that a categorization engine facilitates tracking a measure of clout in an interest-specific fashion or a user. Interest-specific clout measures have a desirable benefit in that participants in a social media platform can easily be connected to other users that are experts or prolific contributors within the area of the participants' interest. Thus, the categorization engine provides a mechanism by which a user of a social media platform can seamlessly build clout (e.g., earned online recognition) in their areas of interest.

In some embodiments, the categorization engine uses statistical techniques to determine the strength of relationship between a keyword and categories (keyword may be taken to refer to “keyword or combination of keywords”). Depending on the number or nature of keywords in a post, a certain number of certain categories will be presented to the user to choose from. After the user chooses a category, strength of relationship calculations may be performed at the macro (e.g., all users or users of a portion of a site or service) and micro levels (e.g. individual users) using statistical sampling techniques including stratified sampling, and cluster sampling. The calculations may be done periodically (e.g., every minute, daily, etc.) to improve the categorization engine's accuracy based on overall and group behavioral insights.

Any suitable method may be employed for selecting one or more categories, number of categories, or both, based on keyword (remembering at all times that in some embodiments keyword can be read as “keyword or combination of keywords”).

In a preferred embodiment, a record of historical counts of keyword-to-category associations is maintained. A keyword count record can be understood as an m×n table A, comprising m rows and n columns, where m is a number of keywords and n is a number of categories. An entry in the table aₘₙ is a record of the number of times (the count) that use of the m^{th} keyword has led to the selection of the n^{th} category. It will be understood that a keyword count record may cover any suitable number of keywords or categories. For example, a record may include hundreds, thousands, tens of thousands, or hundreds of thousands of keywords and tens, or hundreds, or thousands of categories. Preferably, a record includes at least ten or more categories (e.g., 54 categories) and at least hundreds of keywords (e.g., 2500 keywords). Additionally, it will be understood that any suitable data structure can be used to store the count record in a tangible, non-transitory computer readable medium (e.g., m arrays each comprising n entries; one array of m arrays each comprising n entries; a csv file; a text file; hashes; others; or a combination thereof). Table 1 presents a non-limiting example of a keyword count table. A keyword count table can be initially populated artificially—e.g., by simply entering “counts” that match keywords to categories by a priori human expectations. In a preferred embodiment, the table is initialized creating a database for categories and keywords associated with each category which are to be replaced eventually by user-specific data relating to the categories selected per keyword by the specific user. After the periodic updates (e.g., minutes, hours, days, etc.) the actual historical counts from numerous users will quickly override the initial data in certain embodiments creating very accurate and precise prospective category lists.

It will be understood that a keyword by its counts can point to one or a plurality of different categories. A variety of methods may be used to accord a relative strength to each relationship in the one-to-many relationship represented by a row of the keyword count table shown in Table 1. That is, for each category that a keyword points to, a strength can be assigned. Preferably, one or more statistical techniques may be employed to evaluation the strength of the relationship.

In an embodiment, the statistical techniques comprise a chi square goodness of fit test, Herfindahl's concentration index, standard deviations, coefficient of variation, others, or a combination thereof. Using a combination of such techniques, the overall relationship strength between each keyword and categories is determined.

TABLE 1
Key word counts per category

| | Category | | | | | |
|---|---|---|---|---|---|---|
| Keyword | Nightlife | Dining | Recreation | Autos | Motorcycles | Pets |
| Bike | 0 | 0 | 3 | 29 | 135 | 0 |
| House | 0 | 21 | 2 | 3 | 0 | 2 |
| Cat | 0 | 0 | 1 | 0 | 0 | 231 |
| Race | 0 | 0 | 14 | 204 | 106 | 0 |
| Vegan | 2 | 238 | 11 | 0 | 0 | 0 |
| Kitchen | 38 | 315 | 128 | 0 | 0 | 0 |
| New York | 165 | 162 | 166 | 5 | 2 | 2 |
| Weekend | 408 | 60 | 52 | 2 | 9 | 0 |

To illustrate operation of the categorization engine, a non-limiting embodiment is now described. For a keyword count record, certain engine calculation rules may be applied to establish relative strengths with which a keyword indicates various categories. In the non-limiting example, each keyword receives “counts” for each category chosen by a user. Then, for each keyword, the overall standard deviation s and coefficient of variation ε (with respect to non-zero counts in each category) is calculated periodically (e.g., daily). Calculation of s is known in the art and can be found by the sum of the square of the deviation of the counts from the average count, divided by one less than the number of categories (done by keyword over those categories for which there is a non-zero count). Then ε is s divided by the average count. Keywords can be stratified by value of s using, for example, percentiles. Preferably, each key word is identified as Low (L), Medium (M), or High (H).

Continuing the non-limiting example illustrating engine calculation rules, for each keyword, a concentration index may be calculated. Any index may be used that indicates the extent to which the keyword is concentrated in limited numbers of categories. For example, a keyword having all of its counts in one or two categories would have a very high concentration index, and a keyword having its counts distributed evenly across all of the available categories would have a very low concentration index. In some embodiments, the Herfindahl index H is calculated to measure the distribution of a keyword across categories. One of skill in the art will recognize that H can be obtained as the sum of the squares of counts in each row for a keyword. Thus, in a key word with counts only in two categories that each have the same number of counts, H, using normalized values of counts, is 0.5²+0.5² or 0.5. For each keyword, categories can be stratified by value of H using, for example, percentiles. Preferably, each key word is identified as Low (L), Medium (M), or High (H).

The Herfindahl Index H for a keyword will range from 1/N to one, where N is the number of categories with a non-zero count for that keyword. Equivalently, if percentages are used as whole numbers, as in 75 instead of 0.75, the index can range up to 100² (10,000).

In certain embodiments, for a given keyword: H>0.25 indicates H; 0.25>H>0.15 indicates M; and 0.15>H indicates L. One of skill in the art will recognize that strata can be defined by other boundaries.

Proceeding with the non-limiting illustrative example, for each keyword, a chi-square-type value using the observed and the expected count within each category may be calculated periodically. Here, assuming a random distribution of counts across categories, chi-squared-type value for a keyword-to-category relationship can be obtained from: the square of the difference between the observed count and the expected count divided by the expected count.

By following the preceding engine calculation rules, each keyword is stratified to L, M, or H by a suitable value such as coefficient of variation, standard deviation, concentration index, a chi-squared-type value, a Bayesian value, or a combination thereof. These values can be used, as a user enters text, to determine what number of, and which, categories to display.

To illustrate first without reference to the underlying statistics of the engine calculation rules, the following may be determined. If a user enters the keyword “chess”, then 1 single category should be displayed, and that category should be “games—strategy”. If a user enters the keyword “dollhouse”, then 2 categories should be displayed and those categories should be “toys” and “film”. If a user enters the keyword combination “clubs in NY” then 5 categories should be displayed and those categories should be “nightlife,” “music,” “culture,” and “drink.” These determinations may be performed with reference to category display rules.

In certain embodiments, the number and type of categories that will be displayed while a user is making a post may depend on—as each keyword is received—results from the categorization engine. Particularly, for each keyword, the number and nature of displayed categories may be controlled by, in descending order, the keyword overall standard deviation, the keyword overall concentration and statistically significant chi-square-type value in descending order. Particularly, the concentration and standard deviation (or standard deviation, coefficient of variation, others, or a combination thereof) can be used to determine what number of categories to show. For example, if a keyword is very highly concentrated in a category, then it may be determined to show only that category. If a keyword is lowly concentrated (i.e., distributed across a plurality of categories), then it may be determined to show, for example, three categories. Whatever number of categories are determined to show, then the chi-squared-type statistic for each category for that keyword can be used, showing those categories that have the highest values of chi-squared-type statistic. Preferably, in such calculations, a category is included only when the observed value is greater than the expected value. Table 2 summarizes a rubric for selecting categories based on s and H strata.

Following Table 2, for a given keyword, it is determined, for each of s and H, whether that keyword stratifies into H, M, or L. Then the appropriate row of Table 2 is selected. Reading across the selected row, the right-most column gives the number of categories that will be displayed. The categories are selected by choosing categories with highest-scoring chi-squared-type value interactively until the number is reached (e.g., where H is L and s is H, the 3 categories with the highest chi-squared-type value are displayed).

TABLE 2
Rubric for selection of category based on s and H strata.

| | | Number of categories (categories |
|---|---|---|
| | | to be used in order of decreasing |
| Concentration | Standard Deviation | chi-squared-type value where |
| H stratum | s stratum | O > E) |
| H | H | 1 |
| H | M | 1 |
| H | L | 2 |
| M | M | 2 |
| M | H | 2 |
| L | H | 3 |
| L | M | 3 (or request more keywords) |
| L | L | 3 (or request more keywords) |

In certain embodiments, a single number is obtained at the keyword/category level (e.g., 3, or 6), and a structure such as Table 2 is not used.

The initial categories will be displayed after the first keyword is identified and will be updated as soon as any other keywords are identified. Categories are selected based on descending chi-squares statistics values. In certain embodiments, the initial categories are limited to six or fewer.

Systems and methods of the invention are operable to provide iterative engine updates.

In some embodiments, the initial engine relationship between a category and keyword will be updated after a number, for example 50, “count data” are received for each keyword (assuming each keyword can fit into 10 categories) or, for example, 25 “count data” for each combination (assuming each combination can fit in up to 5 categories) and the keyword at-least has H and s both at M or H. The settings for refreshing the engine are adjustable and may be scalable as the service grows.

As shown in FIG. 4, the user has used mobile device 101 to compose new digital media that is being shown in display 125. The new digital media may include, for example, a picture as taken by the user shown in FIG. 1. In some embodiments, systems and methods of the invention provide a media platform that is exclusive to new digital media. Media can include pictures (still or video), sound, characters (input text or text recognized within pictures or sound), media content metadata (e.g., facial or expression recognition from within pictures), media wrapper metadata (EXIF data, time taken, etc.), extrinsic device data (location by GPS, device type), others, or a combination thereof. New can be taken to include material that is recently-created (e.g., within the last five or ten minutes). Digital generally refers to media that is capable of being stored on a tangible, non-transitory computer readable medium such as a solid state memory device (SSD, flash drive), magnetic disk drive, optical drive, or similar.

In certain embodiments, the invention includes the insight that there are desirable benefits in creating a platform for sharing new media. In some embodiments, a system of the invention is used to restrict certain sharing function to only operate with media in which one or more components of the media are newly-created (e.g., fewer than fifteen minutes ago, or five in certain embodiments). Without being bound by any theory, it may be found that users relate to a new media sharing platform as a real-time communication tool in contrast to prior art systems. Thus, in certain embodiments, systems and methods of the invention will only allow the digital media shown in display 125 on mobile device 101 in FIG. 4 to be uploaded or shared if it can be verified that the media was created within a certain amount of time ago. Once media is readied for sharing in the platform, a user can use systems and methods of the invention to share the media with recipient users.

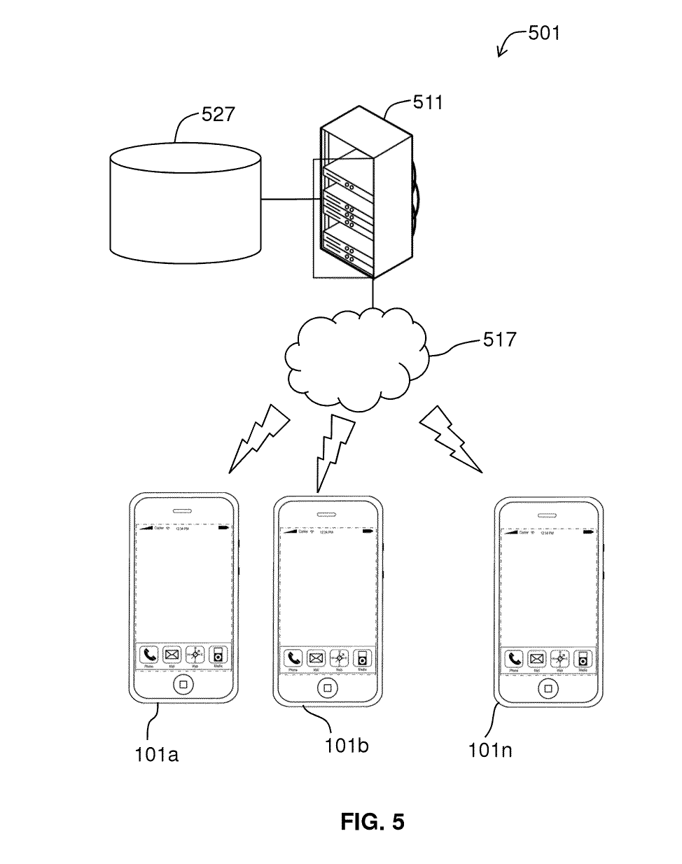

FIG. 5 illustrates a system 501 for sharing media. System 501 may include at least one server computer system 511 operable to communicate with a plurality of devices 101a, 101b, . . . , 101n via communication network 517. Optionally, storage 527 may be associated with system 501. Components of system 501, such as server system 511, can be operated to receive media from a user and publish that media for recipients.

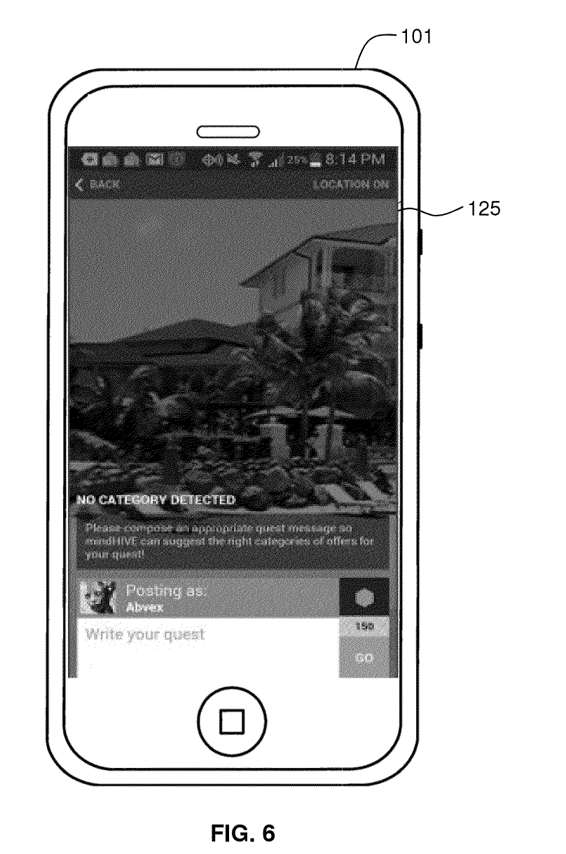

FIG. 6 illustrates use of device 101 for media sharing through a publisher's system. As shown in FIG. 6, a user has captured and is uploading a picture using mobile device 101. Here, the picture shows a resort that the user has snapped a picture of using a mobile device 101. Display 125 shows the picture as it will be shared, and also includes prompts suggesting that the user associate a message with the picture. Display 125 further includes a text input field, other switches (e.g., location of/off), and buttons. In the depicted embodiment, the user is using the media platform to communicate with friends using the picture. In a hypothetical scenario, the user has stumbled upon the depicted vacation resort and wishes to ask her friends if they are familiar with the resort or location. The user snaps a picture of the building and uploads the newly-created digital media into the platform and composes a supplemental message to be published with the picture.

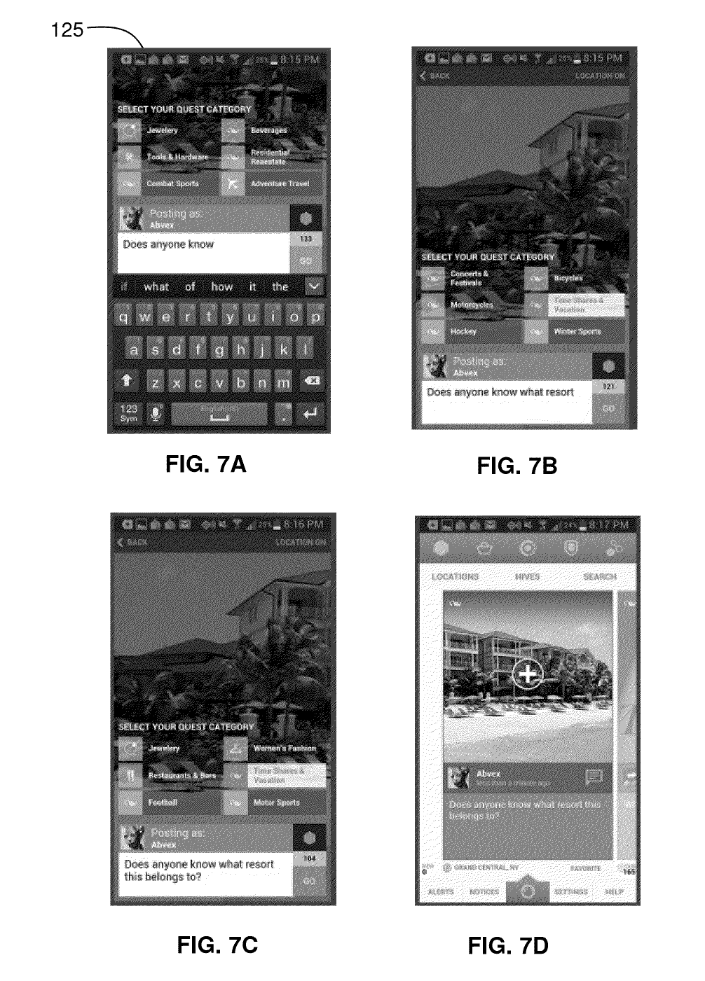

FIGS. 7A-7D illustrate the use of systems and methods of the invention for classifying media in the context of a new digital media sharing platform as implemented through one or more mobile devices as being used by a user to communicate with one or more friends or recipients. Once the user has uploaded the picture, the system can prompt the user to enter text, as shown in FIG. 6. As the user enters text, the system can suggest categories for the user to select based on analysis of the nascent digital media—the picture and text and associated data—as shown in FIG. 7A. As illustrated by FIG. 7B, as the user continues composition of the text message, the system refines the proposed categories. In FIG. 7C, the user has completed composition of the text message. The new media has been published to its intended recipients. The user may proceed to take a new picture and create additional media for communication.

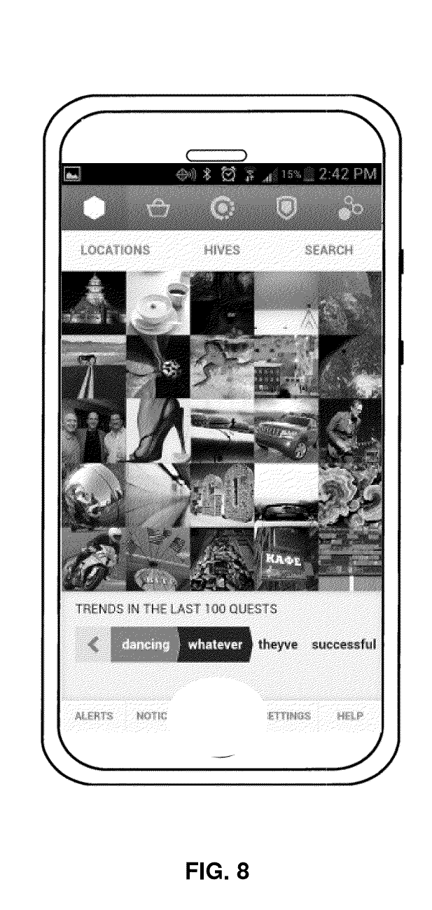

FIG. 8 depicts a home screen that may presented to a user. Here, a user can search for items of interest, get information about their friends, or follow recent trends. In the depicted embodiments, media sharing may be styled as quests and categories may be styled as hives. But it will be recognized that any suitable front end can be used to engage a user.

Since a publisher can use the media platform to engage users within media sharing networks (e.g., “hives” in FIG. 8) that can be narrowly tailored to the particular interests of a user at that time, communication through the media platform can be made to have particular relevance to individual users. For example, a business that wanted to send a communication about Victorian era dollhouses, or about current air fares to Paris, could have those communications sent to users for whom it had been determined that they would be interested in the subject matter. In some embodiments, it may be found that limiting the media sharing platform to new digital media greatly increases the tailoring of interests presently associated with the user and thus the relevance of communication through the platform. Since communication through the platform can have particular relevance, that communication may be found to be particularly effective. Since the systems and methods of the invention offer a platform for effective communication, a business may find that transmitting offers targeted to users through the platform is a desirable method of connecting users to goods and services that may enrich their lives. In some embodiments, systems and methods of the invention provide an offer campaign management tool that businesses or other entities (e.g., non-profits or governments) may use to plan and execute a communication campaign that includes sending offers to users.

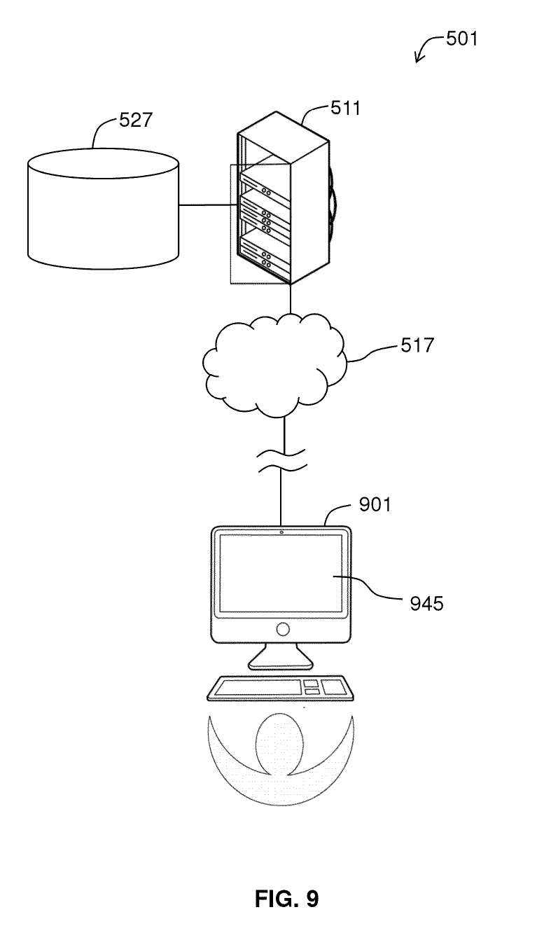

FIG. 9 depicts components of system 501 for use by a business to access a campaign management tool. System 501 can execute software on server 511 to provide tools and functionality described herein. A business that wants to communicate offers to consumers can access the tools through the use of business computer 901. Server 501 can send data and instructions causing display 945 on business computer 901 to present information and receive input from a business (e.g., as an advertiser). As discussed above, a publisher may operate a media sharing platform to allow end-users to communicate by sharing digital media. A business may be customer of the publisher and may pay the publisher to send communications to the users. Systems and methods of the invention can be used to provide a business with campaign planning tools such as a “dashboard”, or home screen from which the business can plan a communication campaign.

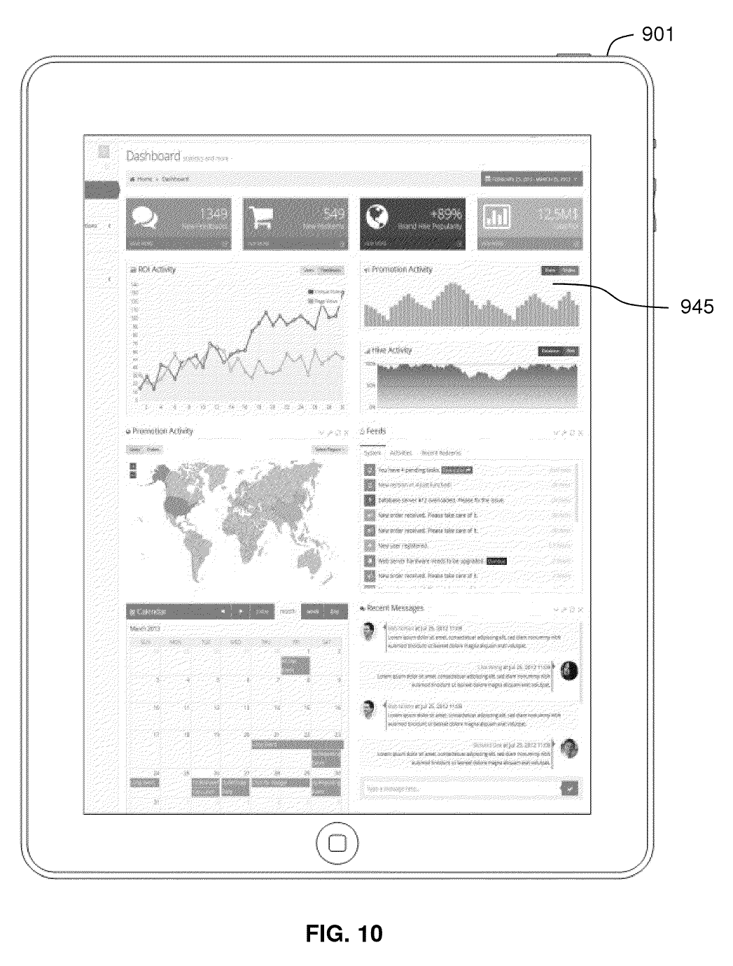

FIG. 10 illustrates a display 945 on a business computer 901 that presents a dashboard from which a business can plan a communication campaign. It should be noted that business computer 901 is depicted as a mobile device in FIG. 10 and as a desktop computer in FIG. 9. It will be appreciated that any suitable computer can be used including, for example, a laptop, a desktop, a smartphone, a tablet, or other. The dashboard shown on display 945 presents a number of different informative links and graphics for the business customer. One of the links may be presented to allow the customer to begin planning a campaign.

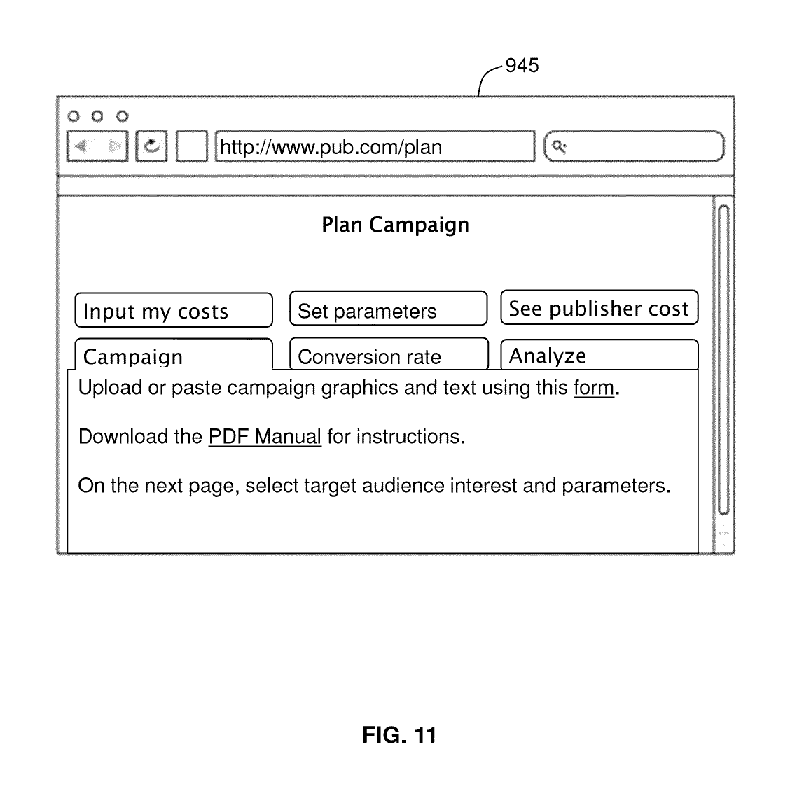

FIG. 11 depicts a display 945 presenting a tool for managing a communication campaign. Through such a tool, a business may optimize profit and investment side variables on a real-time basis to maximize potential return while minimizing the investment risk right from the initial stages of the campaign creation to execution.

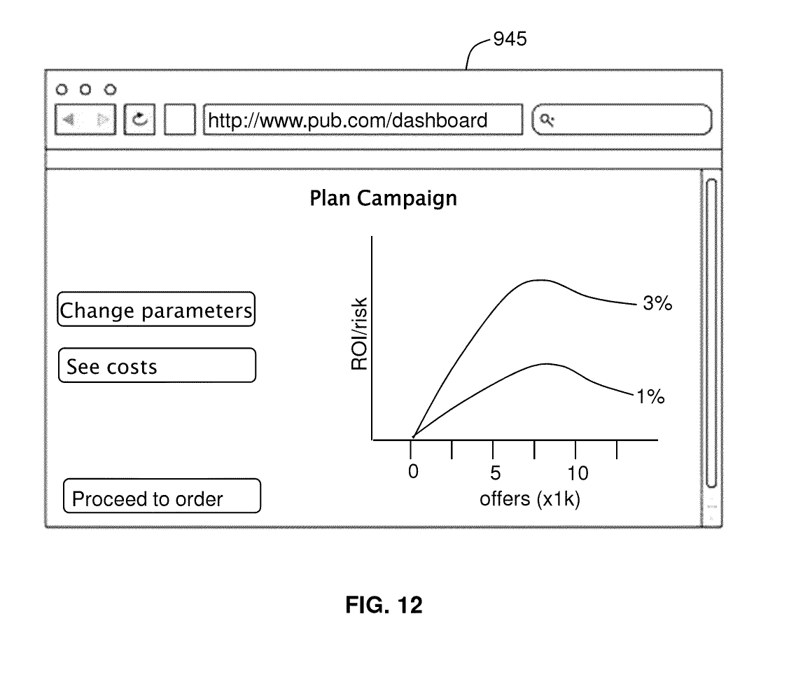

FIG. 12 illustrates a display 945 presenting a sample output of an ROI/risk simulator of the invention. In the presented example, a business has provided certain inputs such as a price and a discount. The ROI/risk simulator has calculated a simulated cost per offer as a function of impressions, prospects, conversion and optionally any other variables over an interval of 0 to 15,000 offers for two different hypothetical conversion rates—1% and 3%. Display 945 gives the business customer tools for changing the model parameters (including changing input costs, conversion rates, etc.), seeing different campaign costs, or ordering a quantity of impressions. It will be appreciated that a communication campaign may have particular value where a user's media is classified by a categorization engine as discussed above, since the business can target the communication campaign to users who have demonstrated an interest in the subject matter of the business's communication campaign. Accordingly, the invention provides methods of classifying media that improve the success of later communication.

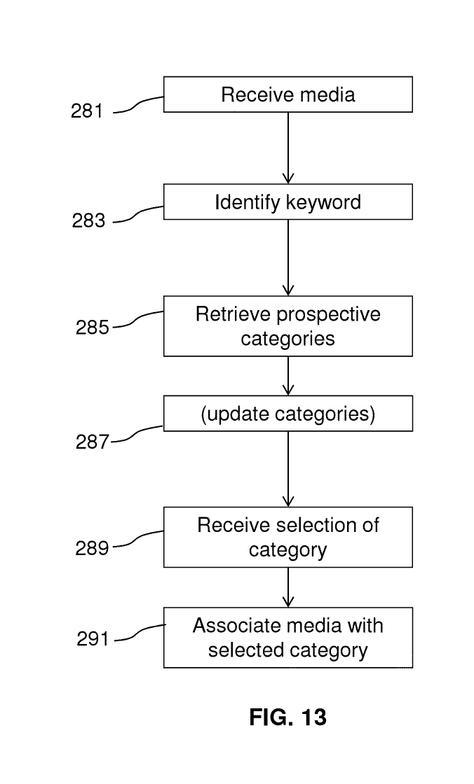

FIG. 13 diagrams steps of methods of the invention according to certain embodiments. System 501 is used to receive 281 media from a user (e.g., from the user's use of a mobile device). A computer processer (such as in a server system 511 or on mobile device 101) operates to identify 283 a keyword in the media as it is being received. The processor can retrieve 285 prospective categories (e.g., from a category count table based on operation of the categorization engine as discussed above). Optionally, the processor can update 287 the categories as more keywords are recognized. The system will receive 289 a selection of a category by the user, and can then associate 291 the media with the selected category.

It will be understood that the categorization engine disclosed herein may be applied to categories albums. Where a user selects a plurality of photos for group upload, that plurality may be styled as an album. The user may enter a text caption (e.g., album title) and keywords may be recognized within that text caption to propose categories. The category that the user selects may then be applied to all of the pictures within the album.

In some embodiments, the classification systems and methods of the invention operate when a text caption is added to a photo that has already been uploaded. It will be recognized that in some instances, a user may upload a picture and then—in a separate step—add a text caption. The methods described herein are applicable in such a context.

In certain embodiments, a user may select more than one category for a picture. That is, as the plurality of prospective categories are being displayed on screen, the user can “touch” (in touch screen embodiments) any number of the categories and indicate being finished (e.g., by hitting a “done” button). The photo will be associated with all of the selected categories.

Systems and methods of the invention operate with mobile devices that do not have touch screens. For example, the proposed categories can each be keyed by a numeral (e.g., 1-6). The user can select the corresponding number from a keypad to select prospective categories.

Such a classification system and method allows for improved communication with users. For example, since the posts (e.g., media) generated by the users are properly classified according to decisions ultimately made by the users, businesses can send communication to those users based on classifications the users are interested in.

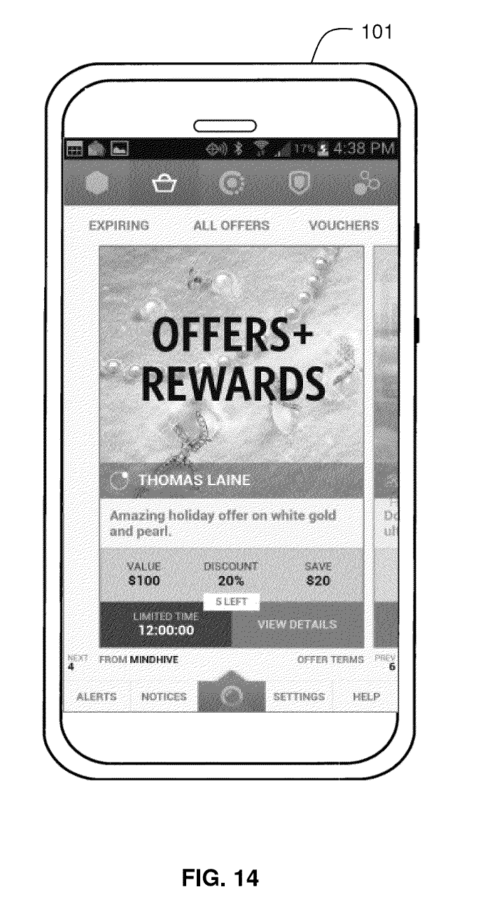

FIG. 14 illustrates a display on a device 101 through which a consumer may receive communications from a business. As shown in FIG. 14, a consumer may have an ability to receive and review communications that include offers (see, e.g., “All Offers” button). Individual offers and their terms can be displayed. For example, a consumer can be offered a product for $20 less than the product's usual retail price. In a preferred embodiment, an offer is a personalized discount or incentive offered to a consumer as opposed to an advertised sale price (although advertising a sale price may additionally or alternatively be accomplished using systems and methods of the invention). Because the offer is personalized, the business can use the communication campaign to engage high value prospect such as, for example, consumers who have expressed interests that overlap with the business's offerings or who have connected to or communicate with other certain participants in the platform. The communication campaigns described herein can be planned and executed using system 501.

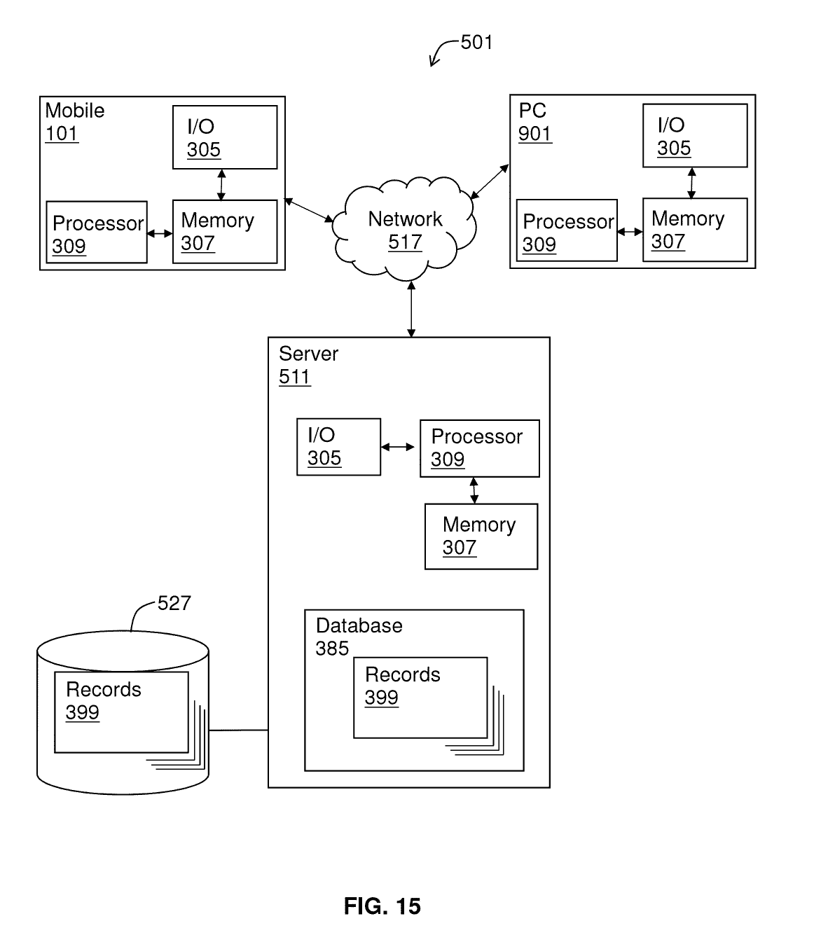

FIG. 15 gives a more detailed schematic of components that may appear within system 501. System 501 preferably includes at least one server computer system 511 operable to communicate with at least one mobile devices 101 via communication network 517. Sever 511 may be provided with a database 385 (e.g., partially or wholly within memory 307, storage 527, both, or other) for storing records 399 where useful for performing the methodologies described herein. Optionally, storage 527 may be associated with system 501. Components of system 501, such as server system 511, mobile 101, business computer 901, are preferably each provided by a computer device. A computer generally includes at least one processor 309 coupled to a memory 307 via a bus and input or output devices 305.

As one skilled in the art would recognize as necessary or best-suited for performance of the methods of the invention, systems of the invention include one or more computer devices that include one or more of processor 309 (e.g., a central processing unit (CPU), a graphics processing unit (GPU), etc.), computer-readable storage device 307 (e.g., main memory, static memory, etc.), or combinations thereof which communicate with each other via a bus.

A processor 309 may include any suitable processor known in the art, such as the processor sold under the trademark XEON E7 by Intel (Santa Clara, Calif.) or the processor sold under the trademark OPTERON 6200 by AMD (Sunnyvale, Calif.).

Memory 307 preferably includes at least one tangible, non-transitory medium capable of storing: one or more sets of instructions executable to cause the system to perform functions described herein (e.g., software embodying any methodology or function found herein); data (e.g., portions of the tangible medium newly re-arranged to represent real world physical objects of interest accessible as, for example, a picture of an object like a motorcycle); or both. While the computer-readable storage device can in an exemplary embodiment be a single medium, the term “computer-readable storage device” should be taken to include a single medium or multiple media (e.g., a centralized or distributed database, and/or associated caches and servers) that store the instructions or data. The term “computer-readable storage device” shall accordingly be taken to include, without limit, solid-state memories (e.g., subscriber identity module (SIM) card, secure digital card (SD card), micro SD card, or solid-state drive (SSD)), optical and magnetic media, and any other tangible storage media.

Any suitable services can be used for storage 527 such as, for example, Amazon Web Services, memory 307 of server 511, cloud storage, another server, or other computer-readable storage. Preferably, storage 527 is used to store records 399 as needed to perform and support operations described herein.

Input/output devices 305 according to the invention may include one or more of a video display unit (e.g., a liquid crystal display (LCD) or a cathode ray tube (CRT) monitor), an alphanumeric input device (e.g., a keyboard), a cursor control device (e.g., a mouse or trackpad), a disk drive unit, a signal generation device (e.g., a speaker), a touchscreen, a button, an accelerometer, a microphone, a cellular radio frequency antenna, a network interface device, which can be, for example, a network interface card (NIC), Wi-Fi card, or cellular modem, or any combination thereof.

One of skill in the art will recognize that any suitable development environment or programming language may be employed to implement the methods described herein. For example, methods here in can be implemented using Perl, Python, C++, C#, Java, JavaScript, Visual Basic, Ruby on Rails, Groovy and Grails, or any other suitable tool. In a preferred embodiment, methods herein are implemented using PHP code. The PHP code returns JavaScript Object Notation (JSON) data. The JSON data may be interpreted in platform-specific or application-specific fashion on mobile device 101 or business computer 901 using, e.g., either a web browser or a dedicated app. In some embodiments, tools accessed via a web browser are provided by using JavaScript to embed JSON data into HTML. For a mobile device 101, it may be preferred to use native xCode or Android Java.

As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method for classifying media, the method comprising:
receiving, at a server computer system comprising a processor coupled to a memory, media transmitted from a mobile device by a user;
identifying, using the processor, a key word within the media;
retrieving from the memory a plurality of prospective categories based on the keyword;
causing the mobile device to display the prospective categories to the user;
receiving at the server computer system a selection by the user of one of the prospective categories; and
associating, using the processor, the media with the selected category.

2. The method of claim 1, wherein retrieving the plurality of prospective categories comprises: selecting the prospective categories from a master list of categories.

3. The method of claim 2, wherein selecting the prospective categories comprises evaluating values stored for the keyword for each of a plurality of parameters for each of the categories in the master list.

4. The method of claim 3, wherein the parameters comprise one selected from the list consisting of: a standard deviation, a concentration index, and a chi-squared value.

5. The method of claim 3, wherein a category is selected from the master list preferentially if one of its associated parameters has a high value.

6. The method of claim 1, further comprising causing the mobile device to display the prospective categories to the user while the user is creating the media using an input mechanism on the mobile device.

7. The method of claim 6, further comprising identifying a second key word after causing the mobile device to display the prospective categories, and then causing the mobile device to display an updated set of prospective categories to the user.

8. The method of claim 6, further comprising identifying a second key word after causing the mobile device to display the prospective categories, and then retrieving an updated plurality of prospective categories based on a combination of the key word and the second key word.

9. The method of claim 1, wherein the media comprises a picture and keywords, the method further comprising posting the media to a media sharing platform.

10. The method of claim 1, wherein the media consists of an image file, an alphanumeric string, and associated metadata.

11. A server system for classifying media, the system comprising:
a processor coupled to a tangible, non-transitory memory containing instructions executable by the processor to cause the system to:
receive media transmitted from a mobile device by a user;
identify a key word within the media;
retrieve prospective categories from the memory using the keyword;
cause the mobile device to display the prospective categories to the user;
receive a selection by the user of one of the prospective categories; and
associate the media with the selected category.

12. The system of claim 11, further operable to select the prospective categories from a master list of categories stored in the memory.

13. The system of claim 12, wherein selecting the prospective categories comprises evaluating values stored for each of a plurality of parameters for each of the categories in the master list.

14. The system of claim 13, wherein the parameters comprise one selected from the list consisting of: a standard deviation, a concentration index, and a chi-squared value.

15. The system of claim 13, further operable to select a category from the master list preferentially if one of the category's associated parameters has a high value.

16. The system of claim 11, further operable to cause the mobile device to display the prospective categories to the user while the user is creating the media using an input mechanism on the mobile device.

17. The system of claim 16, further operable to identify a second key word after causing the mobile device to display the prospective categories, and then cause the mobile device to display an updated set of prospective categories to the user.

18. The system of claim 16, further operable to identify a second key word after causing the mobile device to display the prospective categories, and then retrieve an updated plurality of prospective categories based on the key word and the second key word.

19. The system of claim 11, wherein the media comprises a picture and keywords, the system further operable to post the media to a media sharing platform.

20. A process for classifying and sharing a social media post, the process comprising:
providing a mobile device for use by a user to compose a posting, the posting comprising a picture and a character string;
while the character string is being composed, displaying a list of prospective categories for classification of the posting;
after the list is displayed, updating the list while the character string is further being composed;
receiving a selection from the user of one of the prospective categories; and
sharing the posting with other members of a media platform.
